(19) United States
(12) Patent Application Publication
(10) Pub. No.: US 2009/0115160 A1
(43) Pub. Date: May 7, 2009

(54) COLLAPSIBLE SCOOTER WITH TRI-FOOTBOARD

(76) Inventor: CHIH-HAO CHIU, Kaohsiung City (TW)

Correspondence Address: Dr. BANGER SHIA;Int''l Patent Office of Bang Shia, 102 Lindencrest Ct, Sugar Land, TX, 77479-5201, US

(21) Appl. No.: 11/938,703

(22) Filed: Nov. 12, 2007

(30) Foreign Application Priority Data
Nov. 7, 2007 (TW) 096218775

(51) Int. Cl. B62K 15/00

(52) U.S. Cl. 280/278; 280/264

(57) ABSTRACT

The present invention pertains to a collapsible scooter with tri-footboard providing with a supporting stem attached to the frame body and two steering pivots mounted to both sides thereof for respectively sliding toward a single direction. Further, two auxiliary footboard devices attached their front ends to the steering pivots and their rear ends to the rear wheels, so that the auxiliary footboard devices are positioned toward reverse directions through swinging the steering pivots. In this manner, the rider can alternatively ride the scooter by foot-propelling with the frame footboard or by wriggling rider's buttocks while treading on the auxiliary footboard devices so as to achieve dual operations. Also, the present invention is collapsible for easy storing and carrying and increases its convenience.

### BACKGROUND OF THE INVENTION

1. Field of the Invention

The present invention relates to a scooter, particularly to a collapsible scooter with tri-footboard.

2. Description of the Related Art

Referring to FIG. 1, a conventional scooter 1 comprises a frame body 11 with a frame footboard 111, a steering stem 12 pivotally coupled thereto, and the wheels 13F and 13R rotatably mounted to the body 11 and the stem 12, respectively; wherein two handlebars 121 are extended from the top end of the stem 12 for leading the coasting track of the scooter 1.

While riding, the scooter 1 is used to be propelled through one foot of the rider, and he needs to have an incessant foot-propelling to maintain the sliding of the scooter 1; relatively, some of other scooters may be designed to provide with two frame footboards 111 and two rear wheels (not shown in the figure) at the rear ends or at the underside of the frame footboards 111 for supporting two feet of the rider. However, it may make burden to the feet of the rider, for instance of the continuous propelling by the foot or of solely swinging feet to propel the scooter, which may result of the tiredness of feet. Further, the above operations may also affect the riding pleasure and interest in riding the conventional scooters, which thus require improvement.

### SUMMARY OF THE INVENTION

Therefore, the object of the present invention is to provide a collapsible scooter with tri-footboard, which can be manipulated in dual operations and be easy carrying while being outside.

The scooter in accordance with the present invention comprises a frame body, a steering stem pivotally coupled thereto, and a wheel assembly including a front and two rear wheels; wherein, a supporting stem transversely attaches to the frame body, and two steering pivots are mounted to both sides thereof for respectively sliding toward single directions. Further, two auxiliary footboard devices attach their front ends to the steering pivots and their rear ends for the rear wheels to be pivotally mounted thereon, so as to position the footboard devices toward reverse directions by swinging the steering pivots. Thereupon, the scooter can be alternatively propelled by foot or by wriggling the buttocks of the rider and can be folded up for easy carry and storing, thereby increasing the enjoyment of riding and its convenience.

The advantages of the present invention over the known prior arts will become more apparent to those of ordinary skilled in the art upon reading the following descriptions in junction with the accompanying drawings.

### BRIEF DESCRIPTION OF THE DRAWINGS

FIG. 1 is a side view showing a conventional scooter;

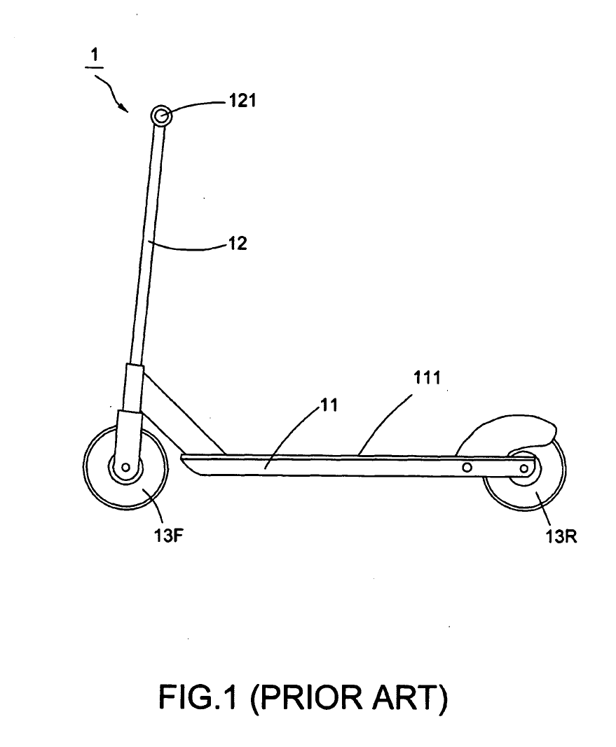

FIG. 2 is a perspective view showing a first preferred embodiment of the present invention;

FIG. 3 is a rear perspective view of FIG. 2 showing the scooter in a folding state;

FIG. 4 is a front perspective view of FIG. 2 showing the scooter in a folding state;

FIG. 5 is a bottom perspective view showing a second preferred embodiment of the present invention;

FIG. 6 is a front perspective view of FIG. 5 showing the scooter in a folding state; and

FIG. 7 is a perspective view showing a third preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

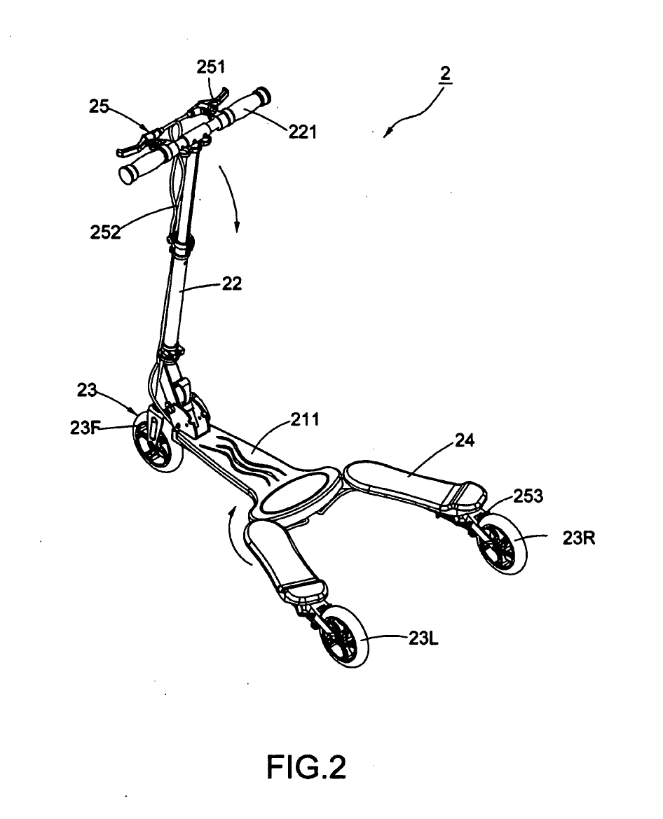

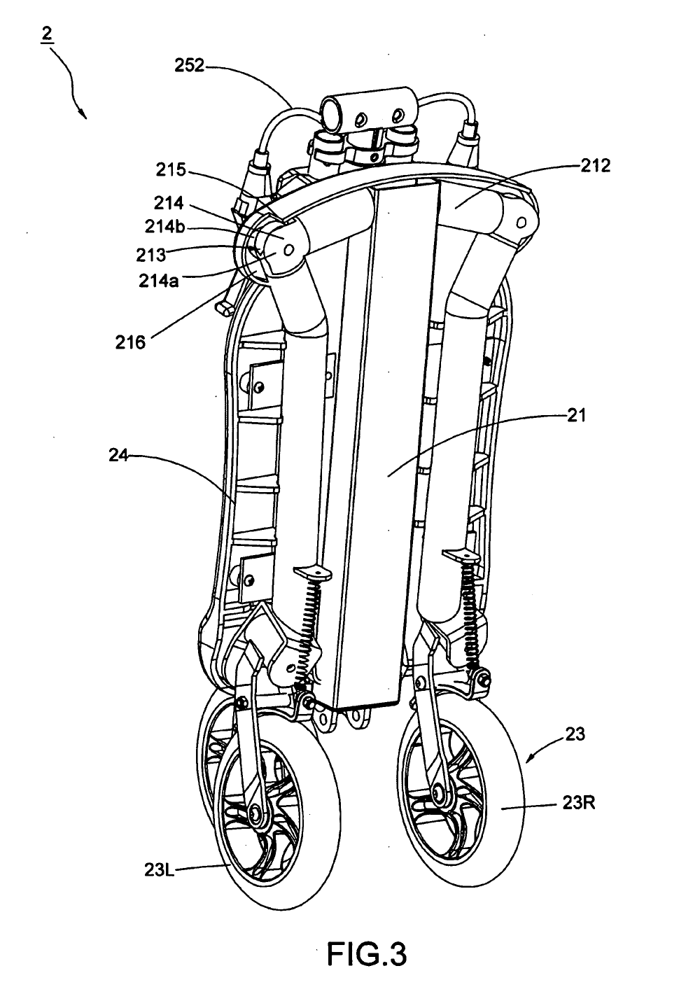

Referring to FIGS. 2 and 3, a scooter 2 of a first preferred embodiment comprises a frame body 21 and a steering stem 22 pivotally attaching to one end of the frame body 21; wherein, the frame body 21 provides with a frame footboard 211 disposed thereon and a supporting stem 212 is transversely attached to the other end of the frame body 21, opposite to the steering stem 212; further a wheel assembly 23 consisting of a front wheel 23F and two rear wheels 23R 23L are rotatably mounted to the bottom end of the steering stem 22 and mounted to an opposed side of the attachment of the steering stem 22 and the frame body 21, respectively. Two handlebars 221 pivotally fastening to a top end of the steering stem 22 and extending therefrom for controlling an orientation normal to a running direction of the scooter 2. Also, a brake device 25 is operatively affixed to the handlebars 221 and includes two brake levers 251, two brake pads 253 respectively mounted at the rear wheels 23R and 23L, and two brake cables 252, by which the brake levers 251 are coupled to the brake pads 253.

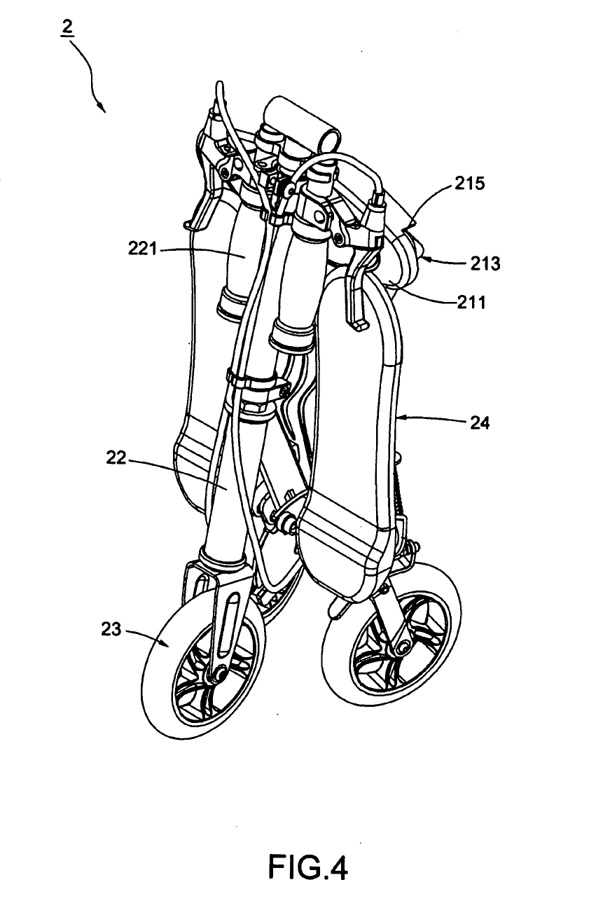

Still referring, two steering pivots 213 are respectively mounted to both sides of the supporting stem 212, and each of which only slides toward a single direction; simultaneously two auxiliary footboard devices 24 attach their front sides to the two steering pivots 213 and outwardly extends therefrom to be positioned toward the reverse directions by swinging two steering pivots 213 (as precisely shown in FIG. 2). In addition, the two rear wheels 23R and 23L can be pivotally mount at rear ends of the two auxiliary footboard devices 24. An axle support bracket 214 consists of two support flanges 214a and 214b and is separately disposed in parallel to the frame footboard 211 for each of the two steering pivots 213 to be pivotally mounted thereto; a fender 215 is extended between the support flanges 214a and 214b, where an inner space 216 is thus defined. Here the fenders 215 of two axle support brackets 214 are adopted that they are extended to be connected as an entire board in the preferred embodiments (shown in FIGS. 3 and 4). Further, the two auxiliary footboard devices 24 are respectively received within the inner spaces 216 of the brackets 214, whereby the auxiliary footboard devices 24 are restricted to be solely swung toward one direction through the axle support brackets 214, and the fender 215 prevent the device 24 from being raised up while unfolding the scooter 2 for using. The two rear wheels 23R and 23L mounted at rear ends of the auxiliary footboard devices 24 thus can be smoothly rotated on the ground.

Referring to FIG. 2 to 4, the scooter 2 can be collapsible while being out or not in used. By means of the steering pivots 213 and axle support brackets 214, each of the auxiliary footboard devices 24 initially moves toward the direction of the frame footboard 211 as arrowed in FIG. 2, so that the auxiliary footboard devices 24 have their front sides shown in FIG. 4 to be located at both sides of the frame footboard 211. Further, taken off the handle bars 221 from the steering stem 22 and then downwardly fold the steering stem 22 toward the frame footboard 211, thus the integral collapsible scooter 2 is formed as illustrated in FIGS. 3 and 4, and it would be easy storing and carrying while being out. Relatively, the collapsible scooter 2 can also be unfolded according to the procedures reverse to the abovementioned steps to generate the unfolded scooter 2 of FIG. 2, whereby the scooter 2 can be exerted instead for walking or simply used for fun in the outside.

Still referring to FIG. 2, the rider can have two ways to ride the scooter 2. Generally, the rider may step one foot on the frame footboard 211, propel the scooter 2 into a forward direction by the other foot to push contacting with the ground, and further rest two feet thereon until a continuous foot-propelling. In this manner, the rider can grasp and squeeze the brake levers 251, and then the brake cables 252 operate the brake pads 253 to slow down the two rear wheels 23R and 23L or to stop them.

Alternatively, the rider may step both feet on the two auxiliary footboard devices 24 and grasp the two handlebars 221; further, he only has to wriggle his waist and buttocks to propel the scooter 2 going into a free space S, and here the track is not shown in the figures. Thereupon, the rider has the above two manipulations to propel the scooter 2 going into a forward direction or into a free track, and he can operate it either for exercising or just for fun.

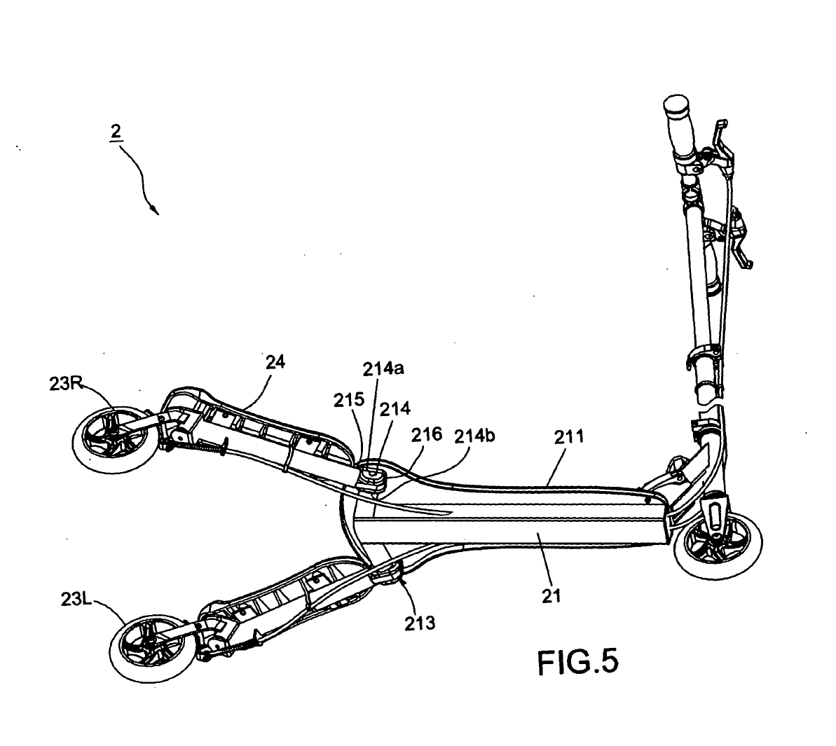

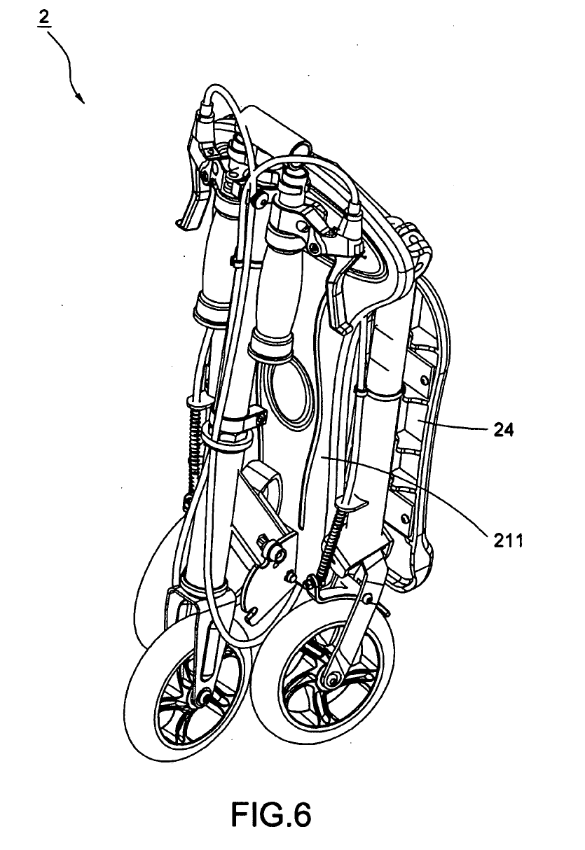

Referring to FIG. 5, the scooter 2 of a second preferred embodiment of the present invention comprises the elements, operations, and collapsible procedures similar to the first preferred embodiment. Differentially, an axle support brackets 214 is disposed perpendicular to the frame footboard 211 for each of the steering pivots 213 to be pivotally mounted thereto and also includes two support flanges 214a and 214b. Further, extended between the two flanges 214a and 214b is a fender 215, and an inner space 216 is thus defined therein for receiving each of the auxiliary footboard devices 24 so as to restrict swinging movements thereof. In this manner, by the configurations of the axle support brackets 214 and the fender 215, the auxiliary footboard devices 24 can only bent toward the frame body 21 and prevent themselves from being raised up while using, whereby the two rear wheels 23R and 23L can be smoothly rotated on the ground. Further, the integral collapsible scooter 2 of the second preferred embodiment is shown in FIG. 6 that the auxiliary footboard devices 24 in a folding state have their front sides to be located at both sides of the frame body 21 (not labeled in this figure) and their rear sides to be at both sides of the frame footboard 211.

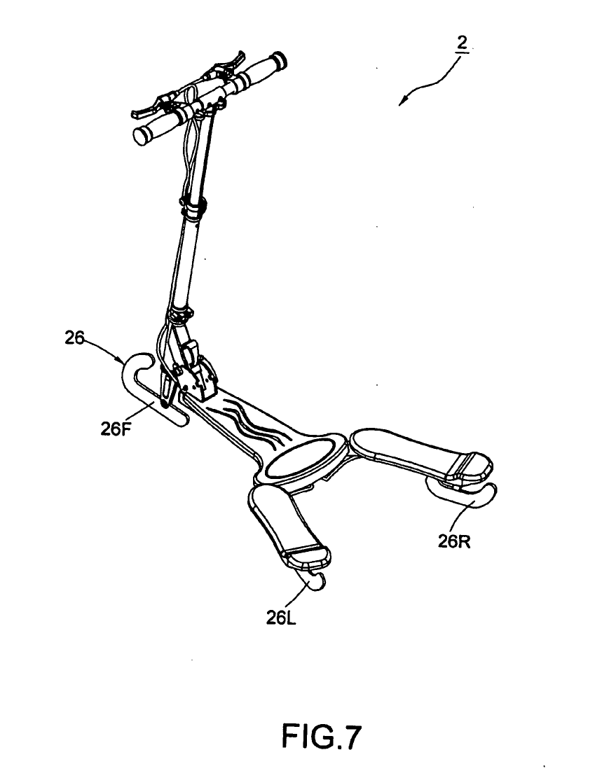

Referring to FIG. 7, the scooter 2 of a third preferred embodiment of the present invention comprises the elements, operations, and collapsible procedures similar to the first preferred embodiment. Particularly, a skate assembly 26 consisting of a front skate blade 26F and two rear skate blades 26R and 26L are pivotally disposed instead of the wheel assembly 23 comprising the front wheel 23F and the two real wheels 23R and 23L in the previous preferred embodiments, so that the rider may have more fun enjoying the ice-skating and be easier to fold the scooter 2 up.

To sum up, the present invention takes advantages of a supporting stem attached to the frame body and two steering pivots mounted to both sides thereof for solely sliding toward single directions; further two auxiliary footboard devices attached their front ends to the steering pivots and their rear ends to the rear wheels, whereby the footboard devices are substantially positioned toward reverse directions through swinging the steering pivots. In this manner, the scooter can have dual operations, for instance of the foot-pushing and the wriggle of one's buttock to propel the scooter going forward or going into a free direction. Moreover, the scooter is collapsible for easy carrying and storing, thereby increasing the enjoyment of riding and its convenience.

While we have shown and described the embodiment in accordance with the present invention, it should be clear to those skilled in the art that further embodiments may be made without departing from the scope of the present invention.

I claim:

1. A collapsible scooter with tri-footboard comprising:
a frame body providing with a frame footboard disposed thereon;
a steering stem pivotally attaching to one end of said frame body;
wherein two handlebars pivotally fastening to a top end of said steering stem for controlling an orientation normal to a running direction of said scooter;
a supporting stem transversely being attached to the other end of said frame body; two steering pivots respectively mounted to both outward sides of said supporting stem and each of which solely sliding toward a single direction; two auxiliary footboard devices attached their front sides to said two steering pivots, so that said two auxiliary footboard devices are substantially positioned toward reverse directions through said two steering pivots; and
a wheel assembly consisting of a front wheel and two rear wheels rotatably mounted to a bottom end of said steering stem and pivotally mount at rear ends of said two auxiliary footboard devices, respectively.

2. The scooter as claimed in claim 1, wherein an axle support bracket consisting of two support flanges is disposed in parallel to said frame footboard for each of said two steering pivots to be pivotally mounted thereto; a fender is extended between said two support flanges, where an inner space is defined for receiving each of said two auxiliary footboard devices so as to restrict swinging movements thereof.

3. The scooter as claimed in claim 1, wherein an axle support bracket consisting of two support flanges is disposed perpendicular to said main footboard for each of said two steering pivots to be pivotally mounted thereto; a fender is extended between said two support flanges, where an inner space is defined for receiving each of said two auxiliary footboard devices so as to restrict swinging movements thereof.

4. The scooter as claimed in claim 1, wherein a brake device is operatively secured to said two handlebars and includes two brake levers fastened to said two handlebars, two brake pads respectively mounted at said two rear wheels, and two brake cables, by which said two brake levers are coupled to said two brake pads.

5. The scooter as claimed in claim 1, wherein a skate assembly is pivotally disposed instead of said wheel assembly.
